(19) United States
(12) Patent Application Publication
(10) Pub. No.: US 2024/0224988 A1
(43) Pub. Date: Jul. 11, 2024

(54) RETENTION SYSTEM FOR A SLATE CALL AND A STRIKER

(71) Applicants: Jordan R. Smith, Lovilia, IA (US); David Kemp, Charlotte, NC (US)

(72) Inventors: Jordan R. Smith, Lovilia, IA (US); David Kemp, Charlotte, NC (US)

(21) Appl. No.: 18/201,661

(22) Filed: May 24, 2023

Related U.S. Application Data
(60) Provisional application No. 63/437,947, filed on Jan. 9, 2023.

(51) Int. Cl. A01M 31/00

(52) U.S. Cl. CPC A01M 31/004

(57) ABSTRACT

A retention system for a slate call and a striker comprises a slate call retention sleeve for holding the slate call and a striker retention sleeve for holding the striker. The slate call retention sleeve is formed as a separate component from the striker retention sleeve. The slate call and striker retention sleeves each have an attachment mechanism for separately attaching the sleeves to an article such as clothing. The slate call and striker retention sleeves are configured to permit use of the slate call and the striker without removing the slate call and the striker from their sleeves and without detaching the sleeves from the article.

### CROSS-REFERENCE TO RELATED APPLICATIONS

This non-provisional application claims the benefit of priority of U.S. provisional patent application No. 63/437,947, filed on Jan. 9, 2023, which is incorporated herein by reference.

### FIELD OF THE DISCLOSURE

This disclosure relates to game calls, and more particularly, relates to a retention system for a slate call and a striker.

### BACKGROUND

A slate call and a striker are hunting tools used to mimic the sounds of a wild turkey or other game. The purpose of this type of game call is to attract game such as turkeys and entice them within range of the hunter who can then attempt to harvest the bird. Hunters use the slate call and the striker to lure turkeys within range. The slate call typically consists of a flat piece of slate and the striker is a small rod or stick that extends between a handle for holding the striker and a tip that is rubbed, scraped, or tapped along the surface of the slate call to create a variety of sounds that mimic the calls of a wild turkey or other game. The slate call is sometimes referred to as a pot call. The sounds that may be produced by rubbing the striker against the slate call include yelps, clucks, purrs, and other sounds that are used by turkeys and other game to communicate with each other and attract mates.

The slate call and the striker are typically carried by the hunter within a pocket, a pack, or other storage, and must be removed from such storage to be used. As the slate call and the striker are typically needed quite often during a hunt, the hunter must frequently retrieve the slate call and the striker from the pocket, pack, or other storage, and then return the slate call and the striker to storage to free the hunter's hands (for using a weapon, for example) when the slate call and the striker are not in use.

Devices have been proposed for holding and storing the slate call and the striker. However, such devices typically provide a single unit for holding both the slate call and the striker, such that either or both the slate call and the striker must first be detached or otherwise retrieved from the holding device before it is available for use by the hunter. The need to retrieve the slate call and the striker and to detach either or both from its holding device delays the ability to simulate the call, creates a risk of dropping the slate call and/or the striker during the retrieval process, and may cause commotion and/or noise that reveals the presence of the hunter to the turkey and diminishes the ability to entice the bird. Moreover, the slate call and/or the striker must be re-attached to its holding device and/or returned to storage before the hunter's hands are freed for other purposes, such as obtaining and using a weapon, which again creates a risk of dropping the slate call and/or the striker and may also create delay and noise or commotion that reduces the chances of a successful hunt.

### SUMMARY

This disclosure provides a retention system for a slate call and a striker in which the slate call and the striker are individually held in separate retention sleeves that are attachable to the hunter's clothing or gear, such that the slate call and the striker can be quickly retrieved and used without needing to be removed from their retention sleeves or detached from the hunter's clothing or gear. The slate call and striker can also be quickly dropped and remain held within their sleeves and attached to the hunter's clothing when game approaches or hands-free movement is otherwise needed.

According to one aspect of this disclosure, a retention system for holding a slate call and a striker is provided. The retention system comprises a slate call retention sleeve for holding the slate call and a striker retention sleeve for holding the striker. The slate call retention sleeve is formed as a separate component from the striker retention sleeve.

In one implementation, the slate call retention sleeve and the striker retention sleeve each have an attachment mechanism for separately attaching the slate call retention sleeve and the striker retention sleeve to an article. The attachment mechanism may be an attachment hole through which a lanyard or looped string may be passed.

In another implementation, the slate call retention sleeve and the striker retention sleeves are configured to permit use of the slate call and the striker without removing the slate call and the striker from their sleeves and without detaching the sleeves from the article.

In a further implementation, the slate call retention sleeve is circular and defines a circular opening, and the slate call retention sleeve comprises an upper lip and a lower lip to assist in securing and encapsulating the slate call within the slate call retention sleeve.

In a still further implementation, the upper lip has a relatively smaller width than the lower lip to allow the slate to be easily fit into the sleeve while also exposing nearly all a top surface of the slate call so that it is available to be rubbed by the striker, and the lower lip has a relatively larger width than the upper lip to define a larger surface for supporting the slate call that does not interfere with or cover sound holes formed on an underside of a double-sided slate call.

In one implementation, the striker retention sleeve comprises a body portion defining an opening for receiving, encapsulating, holding, and protecting the striker.

In another implementation, the opening of the striker retention sleeve is tapered and extends between one end of relatively greater width and another end of relatively smaller width to match a shape of a correspondingly tapered handle of the striker and to form an interference fit of the handle within the striker retention sleeve. In one example, the opening of the striker retention sleeve has a diameter in a range of one-half inch to one inch.

In a further implementation, the slate call retention sleeve and the striker retention sleeve are made from a durable material such as neoprene, silicone, rubber, or rubberized plastic.

According to another aspect of this disclosure, a retention system for holding a slate call and a striker is provided. The retention system comprises a slate call retention sleeve for holding the slate call, and a striker retention sleeve for holding the striker. The slate call retention sleeve includes an attachment mechanism for attaching the slate call retention sleeve to an article, such that the slate call retention sleeve permits use of the slate call without removing the slate call from the slate call retention sleeve and without detaching the slate call retention sleeve from the article. The slate call retention sleeve also includes an opening comprising an upper lip and a lower lip to assist in securing and encapsulating the slate call within the slate call retention sleeve. The upper lip has a relatively smaller width than the lower lip to allow the slate to be easily fit into the sleeve while also exposing nearly all of a surface of the slate call so that it is available to be rubbed by the striker, and the lower lip has a relatively larger width than the upper lip to define a larger surface for supporting the slate call. The slate call retention sleeve is formed as a separate component from the striker retention sleeve and attaches to the article separately from the striker sleeve.

According to a further aspect of this disclosure, a retention system for holding a slate call and a striker is provided. The retention system comprises a striker retention sleeve for holding the striker and a slate call retention sleeve for holding the slate call. The striker retention sleeve includes an attachment mechanism for attaching the striker retention sleeve to an article, such that the striker retention sleeve permits use of the striker without removing the striker from the striker retention sleeve and without detaching the striker retention sleeve from the article. The striker retention sleeve also includes a body portion defining an opening for receiving, encapsulating, holding, and protecting the striker. The opening is tapered and extends between one end of relatively greater width and another end of relatively smaller width to match a shape of a correspondingly tapered handle of the striker and to form an interference fit of the handle within the striker retention sleeve. The striker retention sleeve is formed as a separate component from the slate call retention sleeve and attaches to the article separately from the slate call retention sleeve.

These and other aspects are depicted in the accompanying figures and described below and will be further apparent based thereon.

### BRIEF DESCRIPTION OF THE DRAWINGS

Embodiments of this disclosure are described in detail below with reference to the drawings. Features, aspects, and advantages of this disclosure will be better understood with reference to the following description, appended claims, and accompanying drawings. The drawings provided herein are for illustrative purposes only of selected embodiments, and not all possible implementations, and do not limit the scope of this disclosure.

FIG. 1 is a top perspective view of a slate call retention sleeve holding a slate call, in accordance with this disclosure.

FIG. 2A is a perspective view of the slate call retention sleeve, in accordance with this disclosure.

FIG. 2B is a side view of the slate call retention sleeve of FIG. 2A (in a reverse vertical orientation relative to FIG. 2A), in accordance with this disclosure.

FIG. 2C is a top view of the slate call retention sleeve of FIG. 2A, in accordance with this disclosure.

FIG. 2D is a sectional view of the slate call retention sleeve of FIG. 2A, in accordance with this disclosure.

FIG. 2E is a bottom perspective view of the slate call retention sleeve of FIG. 2A holding a double-sided slate call, in accordance with this disclosure.

FIG. 2F is a sectional view of the slate call retention sleeve holding the double-sided slate call of FIG. 2E (in a reverse vertical orientation relative to FIG. 2E), in accordance with this disclosure.

FIG. 3 is a perspective view of a striker retention sleeve holding a striker, in accordance with this disclosure.

FIG. 4A is a perspective view of the striker retention sleeve (in a reverse vertical orientation relative to FIG. 3), in accordance with this disclosure.

FIG. 4B is a side view of the striker retention sleeve of FIG. 4A (in a reverse vertical orientation relative to FIG. 4A), in accordance with this disclosure.

FIG. 4C is a top view of the striker retention sleeve of FIG. 4A, in accordance with this disclosure.

FIG. 4D is a sectional view of the striker retention sleeve of FIG. 4A, in accordance with this disclosure.

### DETAILED DESCRIPTION

In this detailed description, the summary above, the claims below, and the accompanying drawings, reference is made to certain features and aspects. This disclosure includes all possible combinations of such features and aspects. For example, where a particular feature is disclosed in the context of a particular embodiment or implementation, or in a particular claim, that feature may also be used, to the extent possible, in combination with and/or in the context of other aspects and embodiments of this disclosure.

The term “comprises,” and grammatical equivalents thereof are used herein to mean that other features, components, and steps are optionally present. For example, an article “comprising” (or “which comprises”) components A, B, and C can consist of (i.e., contain only) components A, B, and C, or can contain not only components A, B, and C but also contain one or more other components.

Certain terminology and derivations thereof may be used in the following description for non-limiting purposes of convenience. For example, terms such as “opposite,” “upper,” “lower,” “left,” “right,” “inner,” “outer,” and the like refer to directions in the drawings to which reference is made unless otherwise stated. Similarly, words such as “inward” and “outward” refer to directions toward and away from, respectively, the geometric center of a device or area and designated parts thereof. References in the singular tense include the plural, and vice versa, unless otherwise noted. Terms such as “attached to,” “coupled to,” “affixed to,” “fastened to,” etc. as used herein may refer to a direct or indirect connection.

This disclosure is drawn to a retention system for holding a slate call and a striker. The slate call and the striker are individually held in retention sleeves that are attached to the hunter's clothing or gear, such that the slate call and the striker can be quickly retrieved and used without the need to be removed from their retention sleeves and without the need to be detached from the hunter's clothing or gear. The retention system permits the slate call and the striker to be quickly dropped or released while remaining held within their sleeves and attached to the hunter's clothing or gear when game approaches or when hands-free movement is otherwise needed.

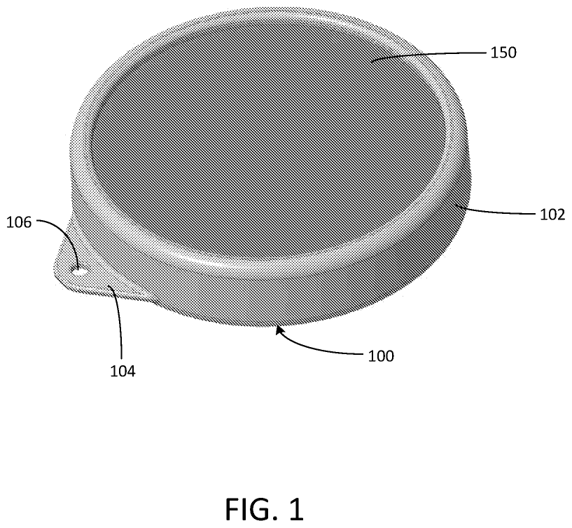

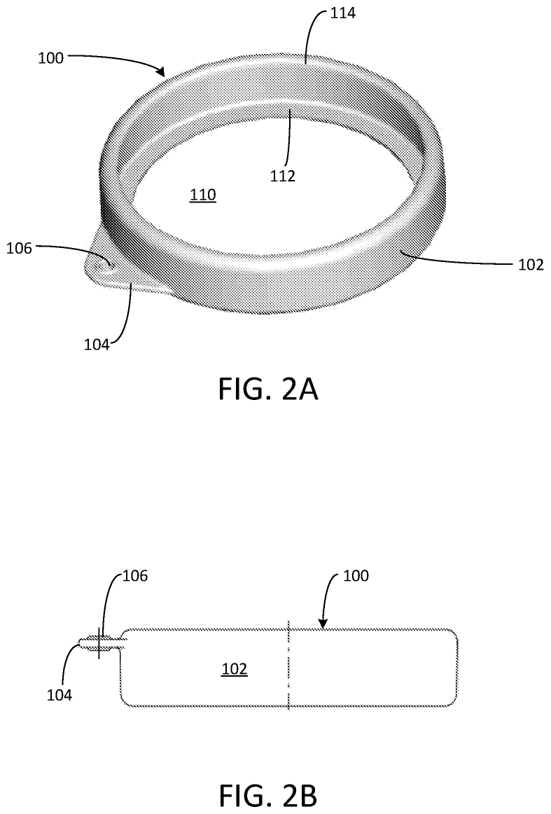

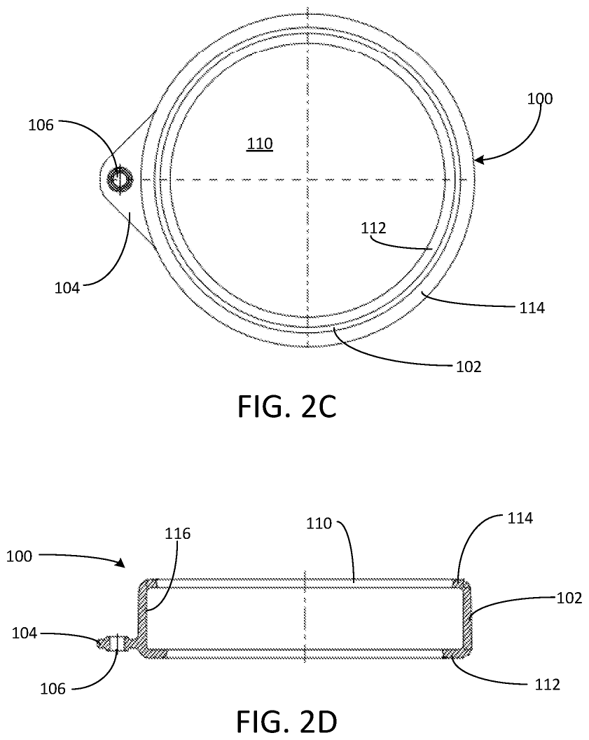

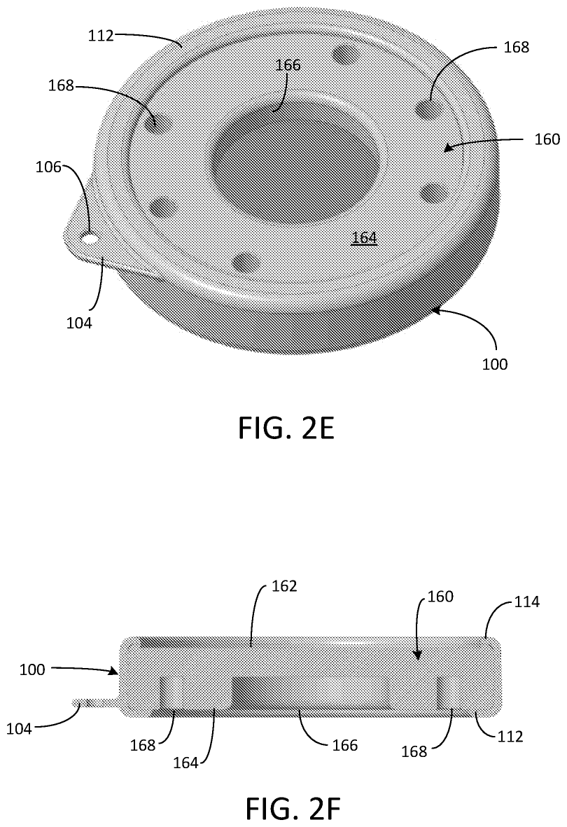

FIG. 1 is a perspective view of a slate call retention sleeve 100 holding a slate call 150, in accordance with this disclosure. FIG. 2A is a perspective view of slate call retention sleeve 100; FIG. 2B is a side view of slate call retention sleeve 100; FIG. 2C is a top view of slate call retention sleeve 100; and FIG. 2D is a sectional view of slate call retention sleeve 100, in accordance with this disclosure.

Slate call retention sleeve 100 includes a body portion 102 defining an opening or aperture 110 for receiving, encapsulating, holding, and protecting slate call 150. Slate call retention sleeve 100 may be made of a durable material such as neoprene, silicone, rubber, rubberized plastic, or any other suitable material, and is designed to fit over slate call 150 to hold and protect it during transportation, storage, and use. In one non-limiting example, slate call retention sleeve 100 is circular and defines a circular opening having a diameter in a range of 3-4 inches.

While slate call retention sleeve 100 is illustrated in FIGS. 1 and 2A-2D for non-limiting purposes of illustration as being circular and defining a circular opening 110 for receiving a circular slate call 150, slate call retention sleeve 100 may be formed in any other suitable shape and may have any suitable dimensions. For example, slate call retention sleeve 100 may alternatively have an oval or rectangular shape defining an oval or rectangular opening for receiving an oval or rectangular slate call.

Slate call retention sleeve 100 includes an attachment mechanism 104 for attaching slate call retention sleeve 100 and its encapsulated slate call 150 to an article such as hunting clothing, gear, a pack, a belt, or any other article. In the non-limiting exemplary embodiment of FIGS. 1 and 2A-2D, attachment mechanism 104 includes an attachment hole 106 through which a lanyard or looped string may be passed to allow slate call retention sleeve 100 and its encapsulated slate call 150 to be, for example, hung around one's neck or clipped to one's clothing via a clip on the lanyard or string. In one non-limiting example, attachment mechanism 104 protrudes about one-half inch from body portion 102. However, attachment mechanism 104 may take any other suitable size, form, and implementation to achieve the purpose of attaching slate call retention sleeve 100 and its encapsulated slate call 150 to clothing, gear, a pack, a belt, or any other article.

As best seen in FIGS. 2C and 2D, slate call retention sleeve 100 includes an upper lip or rim 114 and a lower lip or rim 112 to assist in securing and encapsulating slate call 150 within sleeve 100. Upper lip 114 and lower lip 112, together with body portion 102 of sleeve 100, define a circular channel 116 for receiving and encapsulating slate call 150 within sleeve 100. As can be seen in FIG. 2D, lower lip 112 has a relatively larger width to define a larger surface for supporting slate call 150, whereas upper lip 114 has a relatively smaller width to allow slate call 150 to be easily slipped or fit into sleeve 100, while also exposing nearly all the top surface of slate call 150 so that it is available to be rubbed by the striker. As will be explained with reference to FIGS. 2E-2F, while lower lip 112 has a relatively larger width than upper lip 114, it is not so large that it interferes with sound holes if a double-sided slate call is used. In one non-limiting example, lower lip 112 has a width of about one-half inch and upper lip 114 has a width of about one-quarter inch. As described above, however, slate call retention sleeve 100 may have sizes and shapes other than circular, such as rectangular or oval, in which case channel 116 would have such alternative shape and size as defined by slate call retention sleeve 100.

Slate call 150 is typically a flat piece of slate, which is a type of fine-grained metamorphic rock that is known for its durability and smooth surface. Slate call 150 may be cut or ground to a smooth, flat surface and may be polished or treated in some fashion to enhance its sound-producing properties. By mounting slate call 150 in slate call retention sleeve 100, it is protected and easier to hold and use. While slate call 150 is typically made of slate, as its name indicates, it may alternatively be made of other types of stone, wood, plastic, or any other material suitable for producing a desired game call when the striker is rubbed against it.

Slate call retention sleeve 100 is also configured to work with a double-sided slate call 160, as illustrated in FIGS. 2E-2F. FIG. 2E is a bottom perspective view of slate call retention sleeve 100 holding double-sided slate call 160; and FIG. 2F is a sectional view of slate call retention sleeve 100 holding double-sided slate call 160 (in a reverse vertical orientation relative to FIG. 2E), in accordance with this disclosure.

Double-sided slate call 160 has two sides designed to produce different types of sounds, giving the hunter more options to mimic the various calls of a turkey. In particular, double-sided slate call 160 has a flat upper side 162, which is configured in the same manner as described with reference to the flat upper surface of slate call 150, and an underside 164 having a larger hole 166 in the center and smaller sound holes 168 around the circumference. When a striker is rubbed against the underside of double-sided slate call 160, sound resonates through holes 166 and 168 to generate a unique tone or pitch. Underside 164 may be formed from the same or a different material than upper side 162.

Importantly, as can be seen in FIGS. 2E-2F, lower lip 112 of slate call retention sleeve 100 has a width that is sized so as not to interfere with or cover sound holes 168 around the circumference of underside 164 of double-sided slate call 160.

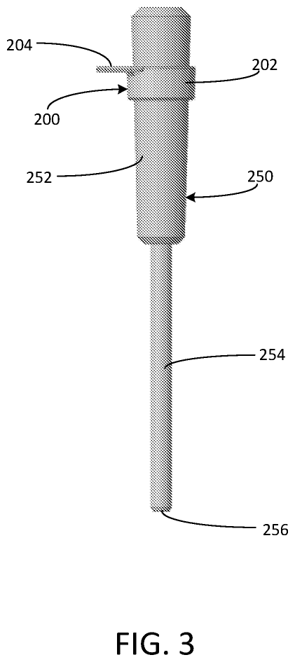

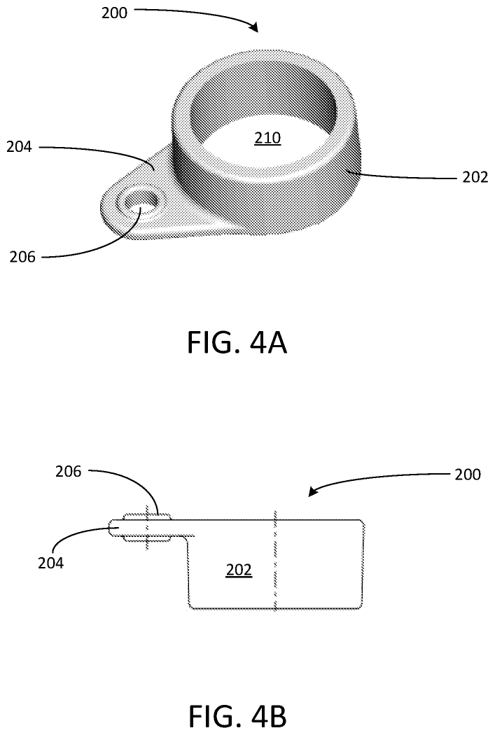

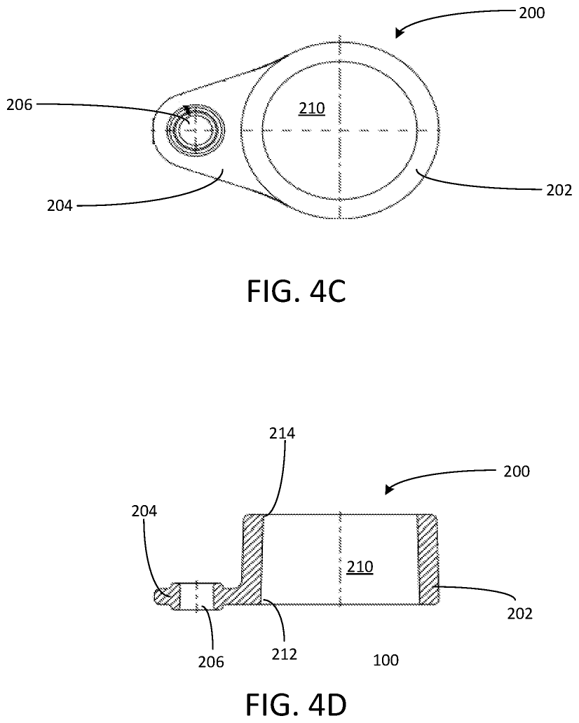

FIG. 3 is a perspective view of a striker retention sleeve 200 holding a striker 250, in accordance with this disclosure. FIG. 4A is a perspective view of striker retention sleeve 200; FIG. 4B is a side view of striker retention sleeve 200; FIG. 4C is a top view of striker retention sleeve 200; and FIG. 4D is a sectional view of striker retention sleeve 200, in accordance with this disclosure.

Striker retention sleeve 200 includes a body portion 202 defining an opening or aperture 210 for receiving, encapsulating, holding, and protecting striker 250. Striker retention sleeve 200 may be made of a durable material such as neoprene, silicone, rubber, rubberized plastic, or any other suitable material, and is designed to fit around handle 252 of striker 250 to hold and protect striker 250 during transportation, storage, and use. In one non-limiting example, striker retention sleeve 200 defines a cylindrical opening 210 having a diameter in a range of one-half to one inch. As will be described in more detail below, cylindrical opening 210 may have a tapered inner surface to match a tapered outer surface of handle 252 of striker 250.

While striker retention sleeve 200 is illustrated in FIGS. 3 and 4A-4D for non-limiting purposes of illustration as defining a cylindrical or circular opening 210 for receiving a correspondingly shaped handle 252 of striker 250, striker retention sleeve 200 may be formed in any other suitable shape and may have any suitable dimensions. For example, striker retention sleeve 200 may alternatively have a rectangular shape defining a rectangular opening for receiving a rectangular handle of a striker.

Striker retention sleeve 200 includes an attachment mechanism 204 for attaching striker retention sleeve 200 and its encapsulated striker 250 to an article such as hunting clothing, gear, a pack, a belt, or any other article. In the non-limiting exemplary embodiment of FIGS. 3 and 4A-4D, attachment mechanism 204 includes an attachment hole 206 through which a lanyard or looped string may be passed to allow striker retention sleeve 200 and its encapsulated striker 250 to be, for example, hung around one's neck or clipped to one's clothing via a clip on the lanyard or string. In one non-limiting example, attachment mechanism 204 protrudes about one-half inch from body portion 202. However, attachment mechanism 204 may take any other suitable size, form, and implementation to achieve the purpose of attaching striker retention sleeve 200 and its encapsulated striker 250 to clothing, gear, a pack, a belt, or any other article.

As best seen in FIG. 4D, opening 210 of striker retention sleeve 200 may be tapered such that it extends between one end 212 of relatively greater width (i.e., the upper end of sleeve 200 when encapsulating striker handle 252 as shown in FIG. 3) and another end 214 of relatively smaller width (i.e., the lower end of sleeve 200 when encapsulating striker handle 252 as shown in FIG. 3) to match the shape of a correspondingly tapered handle 252 of striker 250 and to form an interference fit of handle 252 within sleeve 200. In one non-limiting example, relatively wider end 212 has a width of about 0.824 inches and relatively narrower end 214 has a width of about 0.798 inches. As described above, however, striker retention sleeve 200 and its opening 210 may have sizes and shapes other than cylindrical and/or tapered as is needed to form an interference fit with the portion of striker 250 that is received by sleeve 200.

Striker 250 is typically a small rod or stick 254 that extends between a wider handle 252 that is received in striker retention sleeve 200 and a tip 256 that is rubbed, scraped, or tapped along the surface of slate call 150 that is held by slate call retention sleeve 200 to create a variety of sounds that mimic the calls of a wild turkey. Striker 250 may be made of wood, plastic, metal, or any other material suitable to produce a desired call when rubbed, scraped, or tapped along the surface of slate call 150.

Thus, slate call 150 and striker 250 are each individually and separately held, respectively, by slate call retention sleeve 100 and striker retention sleeve 200. Slate call retention sleeve 100 and its encapsulated slate call 150 may be attached by its attachment mechanism 104 to a hunter's clothing or dangled from the hunter's neck or pack, for example, while striker retention sleeve 200 and its encapsulated striker 250 may be separately attached by its attachment mechanism 204 to the hunter's clothing or gear or dangled from the hunter's neck or pack. In this manner, slate call 150 and striker 250 may be separately and easily accessed and used without the need to remove or return to their sleeves or to be detached or reattached to the hunter's clothing or gear. When the hunter is finished using the slate call and striker, they may simply be released while remaining attached to the hunter, thereby quickly freeing up the hunter's hands to access a weapon, for example. In addition, when the slate call retention sleeve 100 and its encapsulated striker are attached to the hunter or the hunter's gear or clothing, one-handed use of the slate call and striker may be possible by holding the striker (in its sleeve) with one hand and rubbing it against the slate call in its attached or dangled position.

The corresponding structures, materials, acts, and equivalents of all means or step plus function elements in the claims below are intended to include any structure, material, or act for performing the function in combination with other claimed elements as specifically claimed. This description is presented for purposes of illustration and is not intended to be exhaustive or limited to the form disclosed. Many modifications and variations will be apparent to those of ordinary skill in the art without departing from the scope and spirit of the appended claims.

1. A retention system for holding a slate call and a striker comprising:
a slate call retention sleeve for holding the slate call; and
a striker retention sleeve for holding the striker,
wherein the slate call retention sleeve is formed as a separate component from the striker retention sleeve.

2. The retention system of claim 1, wherein the slate call retention sleeve and the striker retention sleeve each have an attachment mechanism for separately attaching the slate call sleeve and the striker retention sleeve to an article.

3. The retention system of claim 2, wherein the attachment mechanism comprises an attachment hole through which a lanyard or looped string may be passed.

4. The retention system of claim 3, wherein the slate call retention sleeve and the striker retention sleeve are configured to permit use of the slate call and the striker without removing the slate call and the striker from their sleeves and without detaching the sleeves from the article.

5. The retention system of claim 1, wherein
the slate call retention sleeve is circular and defines a circular opening; and
the slate call retention sleeve comprises an upper lip and a lower lip to assist in securing and encapsulating the slate call within the slate call retention sleeve.

6. The retention system of claim 5, wherein
the upper lip has a relatively smaller width than the lower lip to allow the slate call to be easily fit into the slate call retention sleeve while also exposing nearly all of a surface of the slate call so that it is available to be rubbed by the striker; and
the lower lip has a relatively larger width than the upper lip to define a larger surface for supporting the slate call without interference with sound holes on an undersurface of a double-sided slate call.

7. The retention system of claim 6, wherein the circular opening of the slate call retention sleeve has a diameter in a range of three to four inches.

8. The retention system of claim 6, wherein the lower lip has a width of about one-half inch, and the upper lip has a width of about one-quarter inch.

9. The retention system of claim 1, wherein the striker retention sleeve comprises a body portion defining an opening for receiving, encapsulating, holding, and protecting the striker.

10. The retention system of claim 9, wherein the opening of the striker retention sleeve is tapered and extends between one end of relatively greater width and another end of relatively smaller width to match a shape of a correspondingly tapered handle of the striker and to form an interference fit of the correspondingly tapered handle within the striker retention sleeve.

11. The retention system of claim 10, wherein the opening of the striker retention sleeve has a diameter in a range of one-half inch to one inch.

12. The retention system of claim 1, wherein the slate call retention sleeve and the striker retention sleeve are made from a durable material selected from a group comprising neoprene, silicone, rubber, and rubberized plastic.

13. A retention system for holding a slate call and a striker comprising:
a slate call retention sleeve for holding the slate call, the slate call retention sleeve comprising:
an attachment mechanism for attaching the slate call retention sleeve to an article, wherein the slate call retention sleeve is configured to permit use of the slate call without removing the slate call from the slate call retention sleeve and without detaching the slate call retention sleeve from the article; and
an opening comprising an upper lip and a lower lip to assist in securing and encapsulating the slate call within the slate call retention sleeve,
wherein the upper lip has a relatively smaller width than the lower lip to allow the slate call to be easily fit into the slate call retention sleeve while also exposing nearly all of a surface of the slate call so that it is available to be rubbed by the striker, and the lower lip has a relatively larger width than the upper lip to define a larger surface for supporting the slate call without interference with sound holes on an underside of a double-sided slate call; and
a striker retention sleeve for holding the striker,
wherein the slate call retention sleeve is formed as a separate component from the striker retention sleeve and attaches to the article separately from the striker sleeve.

14. The retention system of claim 13, wherein the striker retention sleeve comprises a body portion defining an opening for receiving, encapsulating, holding, and protecting the striker.

15. The retention system of claim 14, wherein the opening of the striker retention sleeve is tapered and extends between one end of relatively greater width and another end of relatively smaller width to match a shape of a correspondingly tapered handle of the striker and to form an interference fit of the correspondingly tapered handle within the striker retention sleeve.

16. The retention system of claim 15, wherein the opening of the striker retention sleeve has a diameter in a range of one-half to one inch.

17. A retention system for holding a slate call and a striker comprising:
a striker retention sleeve for holding the striker, the striker retention sleeve comprising:
an attachment mechanism for attaching the striker retention sleeve to an article, wherein the striker retention sleeve is configured to permit use of the striker without removing the striker from the striker retention sleeve and without detaching the striker retention sleeve from the article; and
a body portion defining an opening for receiving, encapsulating, holding, and protecting the striker,
wherein the opening is tapered and extends between one end of relatively greater width and another end of relatively smaller width to match a shape of a correspondingly tapered handle of the striker and to form an interference fit of the correspondingly tapered handle within the striker retention sleeve; and
a slate call retention sleeve for holding the slate call,
wherein the striker retention sleeve is formed as a separate component from the slate call retention sleeve and attaches to the article separately from the slate call retention sleeve.

18. The retention system of claim 17, wherein
the slate call retention sleeve is circular and defines a circular opening; and
the slate call retention sleeve comprises an upper lip and a lower lip to assist in securing and encapsulating the slate call within the slate call retention sleeve.

19. The retention system of claim 18, wherein
the upper lip has a relatively smaller width than the lower lip to allow the slate to be easily fit into the sleeve while also exposing nearly all of a surface of the slate call so that it is available to be rubbed by the striker; and
the lower lip has a relatively larger width than the upper lip to define a larger surface for supporting the slate call without interference with sound holes on an underside of a double-sided slate call.

20. The retention system of claim 19, wherein
the circular opening of the slate call retention sleeve has a diameter in a range of three to four inches, and
the lower lip has a width of about one-half inch and the upper lip has a width of about one-quarter inch.
